(19) United States
(12) Patent Application Publication
(10) Pub. No.: US 2022/0386568 A1
(43) Pub. Date: Dec. 8, 2022

(54) TRAINING COLLAR AND METHOD FOR USE WITH PETS TO PREVENT TUGGING

(71) Applicants: Catherine Myton, Beloite, OH (US); Jason Hill, Beloit, OH (US)

(72) Inventors: Catherine Myton, Beloite, OH (US); Jason Hill, Beloit, OH (US)

(21) Appl. No.: 17/747,178

(22) Filed: May 18, 2022

Related U.S. Application Data
(60) Provisional application No. 63/196,434, filed on Jun. 3, 2021.

(51) Int. Cl. A01K 27/00; A01K 15/02

(52) U.S. Cl. CPC A01K 27/009; A01K 15/021; A01K 27/001

(57) ABSTRACT

Various methods and apparatuses for correcting an animal to heel. Generally, the present disclosure teaches an animal training apparatus for correcting an animal to heel. The animal training apparatus includes a collar adapted to operably engaged with an animal, a stimulus unit operably engaged with the collar, and a control unit operably engaged with the collar and operatively connected with the stimulus unit, wherein the control unit is adapted to operably engage with a leash cord. The animal training apparatus also includes a tension measuring device of the control unit operably engaged with the collar and adapted for measuring tension in the leash cord and producing an electrical signal when the tension exceeds a predetermined tension threshold; wherein the control unit is selectively programmable to generate at least one correction stimulus to the animal when the animal exceeds the predetermined tension threshold set in the control unit.

### CROSS REFERENCE TO RELATED APPLICATIONS

This application claims the benefit of U.S. Provisional Application Ser. No. 63/196,434, filed on Jun. 3, 2021; the disclosure of which is incorporated herein by reference.

### TECHNICAL FIELD

This disclosure relates to an animal training apparatus for teaching animals to heel. Generally, this disclosure relates to an animal training apparatus having a control unit to alert an animal to stop tugging and to teach heeling. Particularly, this disclosure relates to an animal training apparatus having a control unit with electronic components that interface with a stimulus unit to provide an audible correction or a shock correction to an animal to alert the animal to stop tugging and to teach heeling.

### BACKGROUND

Obedience training of animals and pets is a multi-billion-dollar industry. Many people wish to train their pet in a way that matches their lifestyle and interests. Often this involves using a leash or lead in order to keep an animal free but close to its owner.

In the past, a variety of different devices have been used in tandem with a leash to provide some form of stimulus to the pet when too much tension is exerted on the leash. One such device, known as a “choke collar,” is designed to alert the pet by choking its air passageway if the pet pulls too far away from its owner and reaches the end of the leash, or the owner manually manipulates the leash. Another device, known as a “prong collar,” utilizes a plurality of prongs or teeth to engage the neck of the pet when tension is placed on the leash by the pet pulling, or the owner pulling in order to engage the prongs or teeth.

Some of these devices in recent years to help with obedience are so-called “e-collars” (i.e., electronic shock collars). These collars generally work by allowing the owner to use a remote in order to apply a shock to the pet when the pet is misbehaving in some way. The owner must first process the misbehavior, and usually press a button on the remote in order to actuate the shock to the pet.

### SUMMARY

In one aspect, an exemplary embodiment of the present disclosure may provide a pet collar device comprising: a strap portion adapted to fit around the neck of a pet; a stimulus unit connected to the strap portion; and a control unit electrically coupled to the stimulus unit and physically connected to the strap portion, wherein the control unit includes: at least one knob, a strain gauge, a strain gauge amplifier, a microcontroller, a visual indicator, an audible indicator, and a shock inducer.

In another aspect, an exemplary embodiment of the present disclosure may provide a pet collar device comprising: a strap portion adapted to fit around the neck of a pet; a stimulus unit physically connected to the strap portion; a control unit electrically coupled to the stimulus unit and physically connected to the strap portion; and a leash portion physically coupled to the control unit, wherein the control unit includes: at least one knob, a strain gauge, a strain gauge amplifier, a microcontroller, a visual indicator, an audible indicator, and a shock inducer.

In yet another aspect, an exemplary embodiment of the present disclosure may provide a method of operating a pet collar device comprising: attaching a collar to a neck of a pet; setting a stimulus threshold using at least one knob connected to a control unit; and producing a stimulus in response to a stress measured by the control unit related to the tugging on a leash of the pet.

In yet another aspect, an exemplary embodiment of the present disclosure may provide an animal training apparatus. The animal training apparatus includes a collar adapted to operably engaged with an animal. The animal training apparatus also includes a stimulus unit operably engaged with the collar. The animal training device also includes a control unit operably engaged with the collar and operatively connected with the stimulus unit, wherein the control unit is adapted to operably engage with a leash cord. The animal training apparatus also includes a tension measuring device of the control unit operably engaged with the collar and adapted for measuring tension in the leash cord and producing an electrical signal when the tension exceeds a predetermined tension threshold. The control unit is selectively programmable to generate at least one correction stimulus to the animal when the animal exceeds the predetermined tension threshold set in the control unit.

This exemplary embodiment or another exemplary may further include that the control unit comprises a microcontroller operatively connected with the stimulus unit; and at least one control knob operatively connected with the microcontroller; wherein the at least one control knob is adapted to selectively set the microcontroller to generate the at least one correction stimulus to the animal when the animal exceeds the predetermined tension threshold. This exemplary embodiment or another exemplary may further include that the control unit further comprises at least one audible device operatively connected with the microprocessor for generating audible sound when the tension exceeds the predetermined tension threshold; wherein the stimulus unit comprises: a pulse generator operatively connected with the microprocessor and having at least one probe for generating a desired shock power to the at least one probe; and wherein the at least one control knob comprises: a first control knob operatively connected with the microcontroller for controlling the at least one correction stimulus generated by one or both of the stimulus unit and the at least one audible device. This exemplary embodiment or another exemplary may further include that the control unit further comprises a first mode provided by the first control knob for generating a first correction stimulus by the at least one audible device. This exemplary embodiment or another exemplary may further include that the control unit further comprises a second mode provided by the first control knob for generating a second correction stimulus by the stimulus unit. This exemplary embodiment or another exemplary may further include that the control unit further comprises: a third mode provided by the first control knob for generating a third correction stimulus by the at least one audible device and the stimulus unit. This exemplary embodiment or another exemplary may further include that the at least one control knob further comprises: a second control knob operatively connected with the microcontroller; wherein the second control knob is adapted for setting the predetermined tension threshold. This exemplary embodiment or another exemplary may further include the at least one control knob further comprises a third control knob operatively connected with the microcontroller; wherein the third control knob is adapted for setting a predetermined shock power for the pulse generator of the stimulus unit. This exemplary embodiment or another exemplary may further include that the control unit further comprises an amplifier operatively engaged with the tension measuring device and the microprocessor; wherein the amplifier is configured to convert the electrical signal from an analog value to a digital value. This exemplary embodiment or another exemplary may further include that the control unit further comprises a visual indicator operatively engaged with the microprocessor; wherein the visual indicator is adapted to emit light when the tension exceeds a predetermined tension threshold. This exemplary embodiment or another exemplary may further include an electrical connection operatively connecting the control unit with the stimulus unit for to enable the stimulus unit to generate at least one correction stimulus to the animal. This exemplary embodiment or another exemplary may further include that the electrical connection is a wired electrical connection between the stimulus unit and the control unit. This exemplary embodiment or another exemplary may further include that the electrical connection is a wireless electrical connection between the stimulus unit and the control unit.

In yet another aspect, an exemplary embodiment of the present disclosure may provide a method of correcting an animal to heel. The method comprises steps of attaching a collar of an animal training device to a neck region of the animal; selectively setting at least one correction stimulus, via a control unit of the animal training device, when the animal exceeds a predetermined tension threshold set in the control unit; measuring a tension force, via a tension measuring device of the animal training device, applied on a leash of the animal training device by the animal; generating the at least one correction stimulus, via the control unit, in response to the tension applied on the leash by the animal; and correcting an animal to heel.

This exemplary embodiment or another exemplary may further include steps of selectively setting a microprocessor of the control unit, via a first control knob of the control unit, to a first correction stimulus; and activating an audible device of the control unit to generate an audible correction when the animal exceeds the predetermined tension threshold set by the control unit. This exemplary embodiment or another exemplary may further include steps of selectively setting the microprocessor of the control unit, via the first control knob of the control unit, to a second correction stimulus; and activating a pulse generator of a stimulus unit of the animal training device to generate a shock correction when the animal exceeds the predetermined tension threshold set by the control unit. This exemplary embodiment or another exemplary may further include steps of selectively setting the microprocessor of the control unit, via the first control knob of the control unit, to a third correction stimulus; activating the audible device of the control unit to generate the audible correction when the animal exceeds the predetermined tension threshold set by the control unit; and activating the pulse generator of the stimulus unit to generate the shock correction when the animal exceeds the predetermined tension threshold set by the control unit. This exemplary embodiment or another exemplary may further include a step of selectively setting the microprocessor of the control unit, via a second control knob of the control unit, to the predetermined tension threshold from a range of tension thresholds. This exemplary embodiment or another exemplary may further include a step of selectively setting a stimulus unit of the animal training device, via a third control knob of the control unit, to a predetermined shock correction from a range of shock corrections. This exemplary embodiment or another exemplary may further include a step of emitting light, via a visual indicator of the control unit, when the tension exceeds the predetermined tension threshold applied on the leash by the animal. This exemplary embodiment or another exemplary may further include a step of connecting the control unit with the stimulus unit, via an electrical connection, to enable a stimulus unit to generate at least one correction stimulus to the animal, wherein the electrical connection is a wired electrical connection between the stimulus unit and the control unit. This exemplary embodiment or another exemplary may further include a step of connecting the control unit with the stimulus unit, via an electrical connection, to enable a stimulus unit to generate at least one correction stimulus to the animal, wherein the electrical connection is a wireless electrical connection between the stimulus unit and the control unit.

### BRIEF DESCRIPTION OF THE SEVERAL VIEWS OF THE DRAWINGS

A sample embodiment of the disclosure is set forth in the following description, is shown in the drawings, and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top, right, isometric perspective view of an exemplary animal training apparatus for teaching an animal to heel.

FIG. 2A is an enlarged section view of a control unit of the animal training apparatus.

FIG. 2B is an enlarged section view of the stimulus unit of the animal training apparatus.

FIG. 3 is a flowchart of an exemplary logic diagram for the control unit of the animal training apparatus.

FIG. 4A is an operational view of the exemplary animal training apparatus detecting a tension that exceeds a desired tension threshold.

FIG. 4B is another operational view similar to the FIG. 4A, but the control unit produces an audible correction to the animal.

FIG. 5A is an operational view of the exemplary animal training apparatus detecting a tension that exceeds a desired tension threshold.

FIG. 5B is another operational view similar to the FIG. 5A, but the stimulus unit produces a shock correction to the animal.

FIG. 6A is an operational view of the exemplary animal training apparatus detecting a tension that exceeds a desired tension threshold and the control unit produces an audible correction to the animal.

FIG. 6B is an operational view of the exemplary animal training apparatus detecting a tension that exceeds a desired tension threshold and the stimulus unit produces a shock correction to the animal.

FIG. 7 is a top, right, isometric perspective view of another exemplary animal training apparatus.

FIG. 8 is a top, right, isometric perspective view of another exemplary animal training apparatus operatively connected with an existing shock collar.

FIG. 9 is a method flowchart of correcting an animal to heel.

Similar numbers refer to similar parts throughout the drawings.

### DETAILED DESCRIPTION

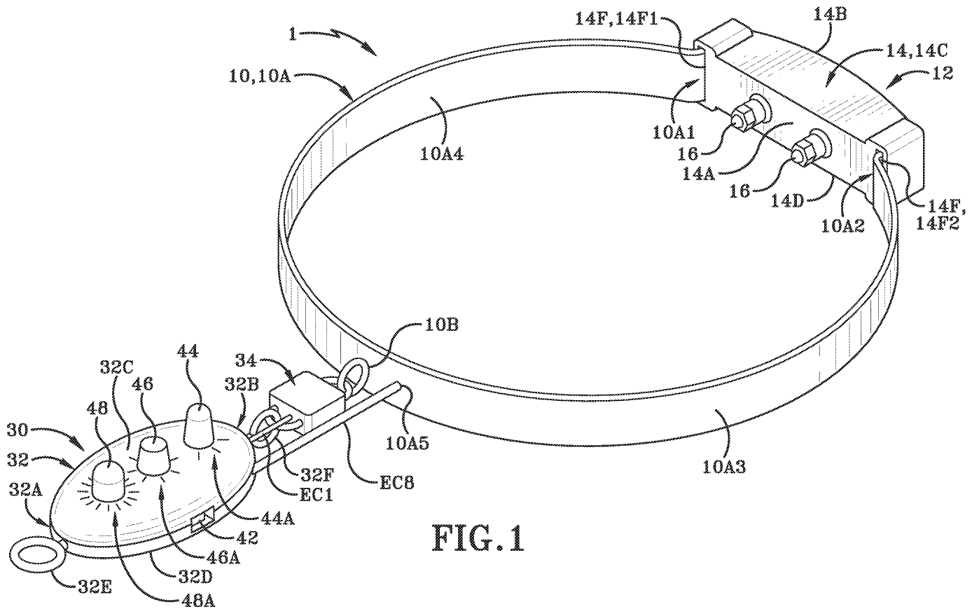

FIGS. 1-6B illustrate a new apparatus, namely, an animal training apparatus or pet training apparatus generally referred to herein as 1. As described in more detail below, the animal training apparatus 1 is configured to train an animal to heel with a handler or owner by preventing tugging and leading created by the animal when said animal is walking with a handler.

Referring specifically to FIG. 1, the animal training apparatus 1 includes a collar 10 that is configured to be operably engaged with and/or fit around a neck region of an animal. While not illustrated herein, the collar 10 may have any suitable configuration and/or mechanism that allows an owner of the animal to suitable fit the collar 10 about a head or neck region of an animal (e.g, an adjustment mechanism that is able to increase or decrease the circumference of the collar to fit around a head or neck region of an animal). As described in more detail below, the collar 10 may operably engage with various components and/or devices for training an animal to heel with a handler or owner by preventing the acts of tugging and leading created by the animal when said animal is walking with a handler.

Still referring to FIG. 1, the exemplary collar 10 has a strap portion 10A that is generally circular in order to accommodate a head or neck region of an animal. The strap portion 10A includes a first end 10A1, a second end 10A2 opposite to the first end 10A2, and a longitudinal axis defined therebetween. The strap portion 10A also includes an outer surface 10A3 that extends along the longitudinal axis of the strap portion 10A between the first end 10A1 and the second end 10A2 and. The strap portion 10A also includes an inner surface 10A4 that extends along the longitudinal axis of the strap portion 10A between the first end 10A1 and the second end 10A2 and contacts with a head or neck region of an animal. In the illustrated embodiment, the outer surface 10A3 and the inner surface 10A4 face in opposite directions on the strap portion 10A. Still referring to FIG. 1, the strap portion 10A may also define a passageway 10A5 that extends from one of the first end 10A1 and the second end 10A2 to a position between the first end 10A1 and the second end 10A2. In the illustrated embodiment, the passageway 105A5 extends from the second end 102A to a position between the first end 10A1 and the second end. Such use and purpose of the passageway 10A5 is described in more detail below.

Still referring to FIG. 1, the collar 10 also includes an attachment member or loop 10B. The attachment member 10B operably engages with the strap portion 10A at a location between the first end 10A and the second end 10B along the outer surface 10D. During training sessions, the attachment member 10B is configured to pivot at the connection between the strap portion 10A and the attachment member 10B to prevent the strap portion 10A from riding up and down on the neck region of the animal during a training session. While described in more detail below, the attachment member 10B enables a handler of the animal to operably engage additional training devices and components to the collar 10 when training the animal to properly heel.

While the attachment member is illustrated with a generally circular and/or curvilinear shape (e.g., a loop), an attachment member of a collar described and illustrate herein may have any suitable size, shape, and/or configuration to enable a handler to operably engage training devices and components to the collar when training an animal to properly heel.

Still referring to FIG. 1, the animal training apparatus 1 may also include a stimulus unit that is generally referred to 12 herein. In the illustrated embodiment, the stimulus unit 12 operably engages with the collar 10, particularly with the strap portion 10A, which is described in more detail below. As described in more detail below, the stimulus unit 12 is configured to generate and discharge an electrical shock to an animal when the collar 10 is fitted to the animal.

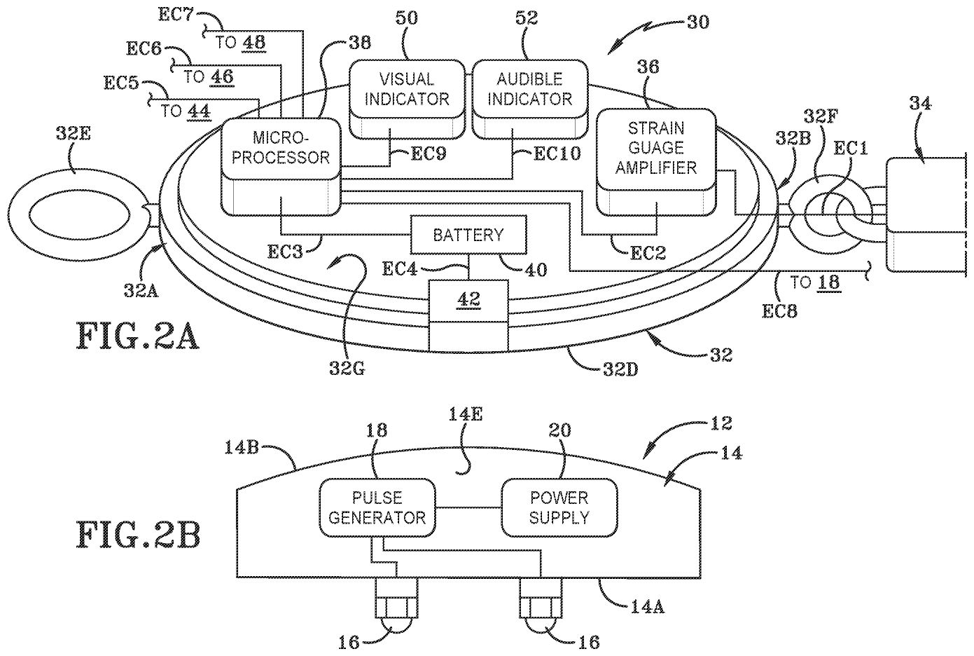

Still referring to FIG. 1, the stimulus unit 12 includes a housing 14 that operably engaged with the collar 10. The housing 14 includes an inward facing side 14A, an outward facing side 14B facing away from the inward facing side 14A and opposite to the inward facing side 14B, a top side 14C extending between the inward and outward facing sides 14A, 14B, and a bottom side 14D extending between the inward and outward facing sides 14A, 14B and facing away from top side 14C. As illustrated in FIG. 2B, a chamber 14E may be collectively defined by the inward facing side 14A, the outward facing side 14B, the top side 14C, and the bottom side 14D.

Referring to FIG. 1, the inward facing side 14A may define at least one aperture 14F enabling at least one end of the collar 10 to operably engage with the stimulus unit 12. In the illustrated embodiment, the inward facing side 14A defines a first aperture 14F1 that enables the first end 10A1 of the strap portion 10A of the collar 10 to operably engage the collar 10 with the stimulus unit 12. In the illustrated embodiment, the inward facing side 14A also defines a second aperture 14F2 that enables the second end 10A2 of the strap portion 10A of the collar 10 to operably engage the collar 10 with the stimulus unit 12. The strap portion 10A feeds into the stimulus unit 14 via the first and second apertures 14F1, 14F2. As a result, the strap portion 10A can be pulled through the aperture 14A and tighten around the neck of the animal, based on the size of the animal. While not illustrated herein, each aperture 14F1, 14F2 may include a retaining mechanism (not shown) in order to retain the strap portion 10A in engagement at the desired size based on the size of the neck or head region of an animal.

Still referring to FIG. 1, the stimulus unit 12 also includes at least one probe 16 that operably engages with the inward facing side 14A of the housing 14. The at least one probe 16 is configured to engage with the neck region of an animal to provide suitable shock correction during training sessions, which is described in more detail below. In the illustrated embodiment, the stimulus unit 12 includes two probes that engage with the neck region of an animal.

As illustrated in FIG. 2B, the at least one probe 16 is operatively connected with a pulse generator 18 of the stimulus unit 12. More particularly, the at least one probe 16 is electrically connected with a pulse generator 18 of the stimulus unit 12. During training sessions, the pulse generator 18 is configured to generate and discharge an electrical signal to the at least one probe 16 to provide shock corrections to an animal during training sessions, which is also described in more detail below.

Further, the stimulus unit 12 may include a power supply or battery 20 that is operatively connected with the pulse generator 18 for providing power to the pulse generator 18 during training sessions. More particularly, the power supply 20 is electrically connected with the pulse generator 18 of the stimulus unit 12. The power supply 20 may also be electrically connected with other components and/or devices provided in the stimulus unit 12 or with other components and/or devices provided in the animal training apparatus 1 depending on the desired implementation.

Referring to FIGS. 1 and 2A, the animal training apparatus 1 also includes a control unit 30 that is operably engaged with collar 10 and operatively engaged with the stimulus unit 12. The components and devices of the control unit 30 are described in greater detail below.

The control unit 30 includes a housing 32 that operably engages with the collar 10. More particularly, the housing 32 of the control unit 30 operably engages with the strap portion 10A of the collar 10 at a location between the first end 10A1 and the second end 10A2. The housing 32 includes a first end 32A, a second end 32B opposite to the first end 32A longitudinally disposed from the first end 32A, and a longitudinal axis defined therebetween. The housing 32 also include a top or first wall 32C that extends between the first end 32A and the second end 32B. The housing 32 also include a bottom or second wall 32D that extends between the first end 32A and the second end 32B; the bottom wall 32D is opposite to the top wall 32C and faces away from the top wall 32C in an opposite direction. Referring to FIG. 1, the housing 32 includes a leash attachment member or leash loop 32E that operably engages with the first end 32A of the housing 32 to enable a leash to operably engage with control unit 30 and the collar 10, which is described in more detail below. Referring to FIG. 2A, the housing 32 also includes a collar attachment member or collar loop 32F that that operably engages with the second end 32B of the housing 32 to enable the collar 10 or other components to be operably engaged with the control unit 30, which is described in more detail below. The housing 32 also defines a chamber 32G that is defined between the first end 32A, the second end 32B, the top wall 32C, and the bottom wall 32D; such use and purpose of the chamber 32G is described in more detail below.

While the leash attachment member 32E is illustrated with a generally circular and/or curvilinear shape (e.g., a loop), a leash attachment member described and illustrate herein may have any suitable size, shape, and/or configuration to enable a leash or similar device to operably engage with a housing of a control unit described and illustrated herein. Similarly, while the collar attachment member 32F is illustrated with a generally circular and/or curvilinear shape (e.g., a loop), a collar attachment member described and illustrate herein may have any suitable size, shape, and/or configuration to enable engagement with other components or devices of a control unit described and illustrated herein, a collar described and illustrated herein, and a stimulus unit described and illustrated herein.

Referring to FIG. 2A, the control unit 30 includes a tension measuring device or strain gauge 34 that operably engages with the housing 32 and the collar 10. More particularly, the strain gauge 34 is configured to operably engage with the collar attachment member 32F and the attachment member 10B of the collar 10. In the illustrated embodiment, the strain gauge 34 is a sensor configured to measure electrical resistance that varies with changes in the strain or tension sensed during training sessions with an animal between the control unit 30 and the collar 10. In particular, the sensed strain or tension value measured by the strain gauge 34 is related to the pulling force on a leash caused by an animal during heel training sessions. During heel training sessions, the strain gauge 34 is configured to continuously sense tension and/or strain values based on the pulling force applied to a leash caused by an animal during training sessions.

In the illustrated control unit 30, the strain gauge 34 operably engages with the house 32, via the collar attachment member 32F, exterior to the chamber 32G of the housing 32 and in fluid communication with the external environment of the housing 32. In one exemplary embodiment, a strain gauge may be housed inside of the chamber 32G defined by the housing 32.

Still referring to FIG. 2A, the control unit 30 also includes a strain gauge amplifier or amplifier 36 that operably engages with the housing 32 and operatively connects with the strain gauge 34. More particularly, the amplifier 36 attaches with one or both of the top wall 32C and the bottom wall 32D of the housing 32 inside of the chamber 32G and electrically connects with the strain gauge 34 via a first electrical connection “EC1” as shown in FIG. 2A. In the illustrated control unit 30, the strain gauge amplifier 36 is configured to convert the analog strain or tension measurement collected by the strain gauge 34 to a digital value to use for heeling correction during training sessions with an animal. In the illustrated embodiment, any suitable components and/or systems known in the art may be used in the amplifier 36 for converting analog signals into digital signals during training sessions.

Still referring to FIG. 2A, the control unit 30 also includes a microcontroller 38 that operably engages with the housing 32 and operatively connects with the strain gauge amplifier 36. More particularly, the microcontroller 38 attaches with one or both of the top wall 32C and the bottom wall 32D of the housing 32 inside of the chamber 32G and electrically connects with the strain gauge amplifier 36 via a second electrical connection “EC2” as shown in FIG. 2A. The microcontroller 38 is any suitable microcontroller or similar device that is known in the art that is logically configured to receive communication from operatively connected components and device and to control or command operatively connected components and devices. As described in more detail below, the microcontroller 38 is selectively configurable to command or instruct specific behavior corrections to an animal based on the desired corrections inputted by a handler of the animal.

Still referring to FIG. 2A, the control unit 30 also includes a battery unit 40 that operably engages with housing 32 and operatively connects with at least the microcontroller 38. More particularly, the battery unit 40 attaches with one or both of the top wall 32C and the bottom wall 32D of the housing 32 inside of the chamber 32G and electrically connects with the microcontroller 38 via a third electrical connection “EC3” as shown in FIG. 2A. The illustrated battery unit 40 is configured to provide electrical power to at least the microcontroller 38, via the third electrical connection “EC3”, to enable operation of the microcontroller 38. While not illustrated herein, the battery unit 40 may be operatively engaged with and/or electrically connected with other devices and components provided in the control unit 30, the stimulus unit 12, and other devices of the animal training apparatus 1 for providing electrical power.

In one instance, the battery unit 40 may replaceable and/or removable from the housing 32 when the battery unit 40 ceases to provide electrical energy to the microcontroller 38 and/or other devices operatively connected with the battery unit 40. In another instance, the battery unit 40 may be integral with the housing 32 and be rechargeable with an external power source (not illustrated) via an integrated battery charging port 42. As illustrated in FIG. 2A, the battery charging port 42 may be operatively connected with the battery unit 40 via a fourth electrical connection “EC4” to transfer electrical from an external power source to the battery unit 40.

Referring to FIG. 1, the control unit 30 may include at least one control knob that operably engages with the housing 32 and operatively engages with the microcontroller 38. More particularly, the at least one control knob attaches with one or both of top wall 32C and the bottom wall 32D of the housing 32 and electrically connects with the microcontroller 38 via at least one electrical connection as shown in FIG. 2A. The at least one control knob has a body and a shape that enables a handler to grasp the at least one control knob prior to or during training sessions for selecting suitable behavior corrections for an animal, which is described in more detail below. During training sessions, a handler may selectively set or program the microcontroller 38 to at least one stimulus correction via the at least one control knob. During training sessions, a handler may also selectively set or program the microcontroller 38 to enable a range of stimulus correction intensity based on attributes of an animal via the at least one control knob (e.g., size of animal, weight of animal, and/or other attributes of the like for enabling a desired stimulus correction intensity).

In the illustrated control unit 30, a first control knob or behavior correction stimulus knob 44 operably engages with the housing 32 and operatively engages with the microcontroller 38. More particularly, the first control 44 knob attaches with the top wall 32C of the housing 32 and electrically connects with the microcontroller 38 via a fifth electrical connection “EC5” as shown in FIG. 2A. The first control knob 44 is operative to rotate and, in the exemplary embodiment, is movable between three locations indicated by indicia 44A. As will be discussed later with respect to operation, the first knob 16 in the exemplary embodiment is used to control a behavior correction module logically provided with the microcontroller 38. In the exemplary embodiment, when the first knob 44 is selected to a first position upon reference to indicia 44A, the microcontroller 38, via the behavior correction module, will provide an audible correction to an animal if the animal causes tension and/or strain greater than a desired tension threshold. Further, when the first knob 44 is in a second position upon reference to indicia 44A, the microcontroller 38, via the behavior correction module, will provide a shock correction to an animal with use of the stimulus unit 12 if the animal causes tension and/or strain greater than a desired tension threshold. Finally, when the first knob 44 is in a third position upon reference to indicia 44A, the microcontroller 38, via the behavior correction module, will provide an audible correction to an animal followed by or simultaneously with a shock correction to the animal.

In the illustrated control unit 30, a second control knob or tension threshold knob 46 operably engages with the housing 32 and operatively engages with the microcontroller 38. More particularly, the second control knob 46 attaches with the top wall 32C of the housing 32 and electrically connects with the microcontroller 38 via a sixth electrical connection “EC6” as shown in FIG. 2A. The second control knob 46 is operative to rotate and, in the exemplary embodiment, is used to control a leash pull threshold logically provided with the microcontroller 38. As stated differently, a selected leash pull threshold by a handler sets a desired pull load trigger point at which the behavior correction module will occur based on the setting of the second control knob 44. The range of the leash pull threshold that is available to be selected by the handler is referenced by an indicia 46A. In one instance, a handler may set a desired leash pull threshold based on the size and strength of the animal. In another instance, a handler may set a desired leash pull threshold based on a desired distance between the handler and the animal when the handler is training the animal to heel.

In the illustrated control unit 30, a third control knob or shock power knob 48 operably engages with the housing 32 and operatively engages with the microcontroller 38. More particularly, the third control knob 48 attaches with the top wall 32C of the housing 32 and electrically connects with the microcontroller 38 via a seventh electrical connection “EC7” as shown in FIG. 2A. The third control knob 48 is operative to rotate and, in the exemplary embodiment, is used to select the percentage of power delivered through the shock correction via the microcontroller 38. During training sessions, the microcontroller 38 will communicate at least one shock correction to be generated by the stimulus unit 14, via an eighth electrical connection “EC8” as shown in FIGS. 1 and 2A, at the desired shock power if shock correction is selected by the first control knob 44. Specifically, the microcontroller 38 will communicate at least one shock correction to be generated by the pulse generator 18, via the eighth electrical connection “EC8” as shown in FIGS. 1 and 2A, at the desired shock power if shock correction is selected by the first control knob 44. The pulse generator 18 will then transfer this generated shock power to the at least one probe 16 to provide the at least one shock correction to the animal. The range of the shock power that is available to be selected by the handler is referenced by an indicia 48A. In one exemplary embodiment, a handler may set a desired shock power based on the size and strength of the animal upon receiving a shock correction via the at least one probe 16.

In the illustrated animal training apparatus 1, the first control knob 44, the second control knob 46, and the third control knob 48 are operatively connected with the microcontroller 38 of the control unit 30 via at least one electrical connection to provide communication between the microcontroller 38 and each of the first control knob 44, the second control knob 46, and the third control knob 48. In the illustrated embodiment, each of the first control knob 44, the second control knob 46, and the third control knob 48 is operatively connected with the microcontroller of the control unit 30 via a wired connection. In one exemplary embodiment, each of the first control knob 44, the second control knob 46, and the third control knob 48 is operatively connected with the microcontroller of the control unit 30 via a wireless or peer-to-peer connection. Examples of suitable wireless connection include, but are not limited to, Bluetooth technology, infrared technology, WiFi Direct technology, near field communication (NFC), cellular technologies, and other suitable technologies of the like to operatively connect each of the first control knob 44, the second control knob 46, and the third control knob 48 with the microcontroller of the control unit 30 via wireless connections.

Referring to FIG. 2A, the control unit 30 may include a visual indicator 50 that operably engages with the housing 32 and the operatively connects with the microcontroller 38. More particularly, the visual indicator 50 attaches with top wall 32C of the housing 32 and electrically connects with the microcontroller 38 via a ninth electrical connection “EC9” as shown in FIG. 2A. In the illustrated embodiment, the visual indicator 50 is a light source that is configured to emit light when an animal exceeds a desired tension threshold selected by a handler. As such, the microcontroller 38 will send at least one continuous signal to the visual indicator 50, via the ninth electrical connection “EC9”, to emit light when an animal exceeds a desired tension threshold selected by a handler. The visual indicator 50 will provide visual indication and/or notice to the handler when the animal causes a pulling force on a leash that exceeds and/or is greater than the predetermined tension threshold set by the handler.

Referring to FIG. 2A, the control unit 30 may include an audible indicator 52 that operably engages with the housing 32 and the operatively connects with the microcontroller 38. More particularly, the audible indicator 52 attaches with one or both of the top wall 32C and the bottom wall 32D of the housing 32 inside of the chamber 32G and electrically connects with the microcontroller 38 via a tenth electrical connection “EC10” as shown in FIG. 2A. In the illustrated embodiment, the audible indicator 52 is a buzzer or sound speaker that is configured to generate an audible or sound correction when an animal exceeds a desired tension threshold selected by a handler. As such, the microcontroller 38 will send at least one continuous signal to the audible indicator 52, via the tenth electrical connection “EC10”, to emit a sound when an animal exceeds a desired tension threshold selected by a handler. The audible indicator 52 will provide audible indication and/or notice to the handler and the animal when the animal causes a pulling force on a leash that exceeds and/or is greater than the predetermined tension threshold set by the handler. The illustrated audible indicator 52 is desired to be used as a correction tool for the animal when the animal exceeds the desired tension threshold set by the handler.

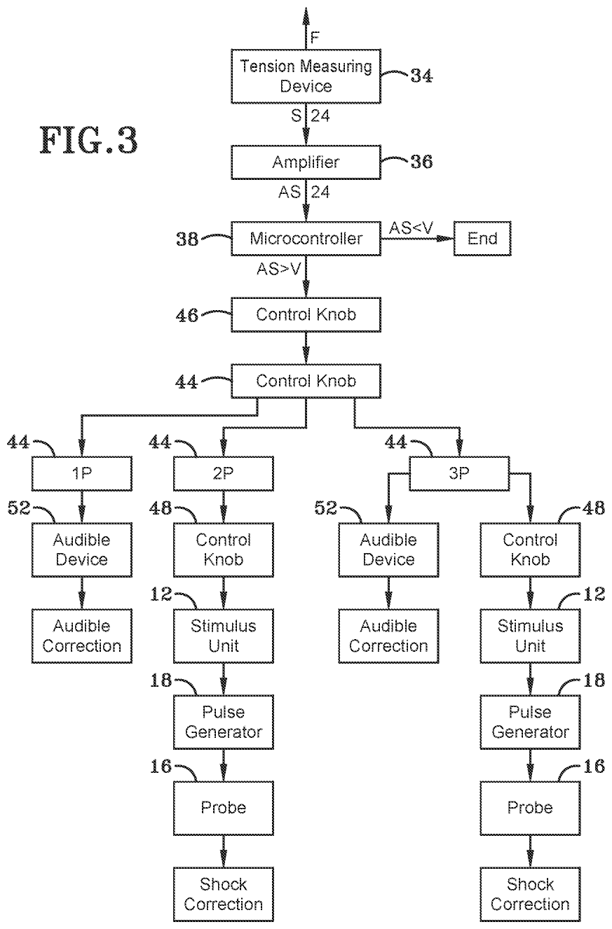

FIG. 3 (FIG. 3) is a block diagram of the circuitry and logic for effectuating control of the animal training apparatus 1. Initially, the strain gauge 34 senses a force “F” proportional to and as a result of a strain or tension force being placed on the control unit 30 attached to the collar attachment member 32F between the dog collar 10 and a leash on the leash attachment member 32E. An analog tension signal “S” is output from the strain gauge 34 to the strain gauge amplifier 36 via the first electrical connection “EC1” that connects the strain gauge 34 and the strain gauge amplifier 26 with one another. Once received, the strain gauge amplifier 36 amplifies the analog tension signal “S” to an amplified digital signal “AS”. Once amplified, the amplified signal “AS” is output from the strain gauge amplifier 36 to the microcontroller 38 via the second electrical connection “EC2” connecting the strain gauge amplifier 36 and the microcontroller 38 with one another.

Once received, the microcontroller 38 is configured to then compare the amplified signal “AS” to the value of the predetermined tension threshold selected or inputted into the microcontroller 38 by the handler via the second control knob 46. If the amplified signal “AS” is less than the value “V” (illustrated a “AS<V” in FIG. 3) of predetermined tension threshold inputted into the microcontroller 38 by the handler via the second control knob 46, the microcontroller 38 logically determines to do nothing in response to the signal “AS”. However, if the value “AS” is greater than the value “V” of predetermined tension threshold inputted into the microcontroller 38 by the handler via the second control knob 46, the microcontroller 38 will illuminate a visual indicator 50 and then continue to determine the selected stimulus corrections to generate for correcting and training an animal to heel per the handler's desired behavior corrections.

Once the value “AS” is greater than the value “V” of predetermined tension threshold inputted into the microcontroller 38 by the handler via the second control knob 46, the microcontroller 38 will then check the status of the first control knob 44 per the behavior correction module.

When the first control knob 44 is selected to a first position “1P”, the microcontroller 38 will provide a signal to the audible indicator 52 to provide an audible indication or correction sound to the animal.

When the first control knob 44 is selected to a second position “2P”, the microcontroller 38 will check the value of the third control knob 48 selected by the handler prior to performing a training session. Based on this value, the microcontroller 38 will send at least one shock correction signal to the stimulus unit 12 that is proportional to the value of the third control knob 48 selected by the handler. Specifically, the at least one shock correction signal is output to the pulse generator 18 which, in turn, sends a signal to the at least one probe 16 resulting in at least one shock correction to the animal.

When the first control knob 44 is selected to a third position “3P” the microcontroller 28 will provide a signal to the audible indicator 52 to first provide an audible indication or sound to the animal for corrective purposes. Upon this audible indication, the microcontroller 28 may pause operation for a desired time period to determine if the animal still causes a pulling force that exceeds the selected tension threshold. In the exemplary embodiment, the paused operation of the microcontroller 28 may be between one-half second and five seconds. Upon the conclusion of paused operation, the microcontroller 28 may check the value of the third control knob 48. Based on this value, the microcontroller 38 may send at least one shock correction signal to the stimulus unit 12 that is proportional to the value of the third control knob 48 selected by the handler. Specifically, the at least one shock correction signal is output to the pulse generator 18 which, in turn, sends a signal to the at least one probe 18 resulting in at least one shock correction to the animal. In this mode, the at least one shock correction provided to the animal may be delayed to determine if the animal still causes a pulling force that exceeds the selected tension threshold after the audible correction has been generated.

Having now described the components and devices of the animal training apparatus 1, methods of using the animal training apparatus 1 for correcting an animal to heel are described in more detail below.

Prior to a training session, a handler 60 fits the animal training apparatus 1 to an animal 70 to teach the animal 70 to heel at a suitable distance relative to the handler 60. In the illustrated embodiment, handler 60 fits the animal training apparatus 1 to a dog 70 to teach the dog 70 to heel at a suitable distance relative to the handler 60. In other exemplary embodiments, an animal training apparatus described and illustrated herein may be used with any suitable animal for the purposes of teaching an animal to heel. Once the collar 10 and the probes 16 of the animal training apparatus 1 are fitted to the animal 60, the handler 70 may then attach a leash 80 to the control unit 30, specifically to the leash attachment member 32E of the control unit 30.

Prior to a training session, the handler 60 may also set the first control knob 44 to a desired position, via reference to the indicia 44A, for a desired mode. As stated previously, the handler 60 may desire to set the first control knob 44 to the first position, by referencing to the indicia 44A, if the handler 60 only wants an audible stimulus correction via the audible indicator 52. The handler 60 may also desire to set the first control knob 44 to the second position, by referencing to the indicia 44A, if the handler 60 only wants a shock stimulus correction via the stimulus unit 12. The handler 60 may also desire to set the first control knob 44 to the third position, by referencing to the indicia 44A, if the handler 60 wants both an audible stimulus correction, via the audible indicator 52, along with a shock stimulus correction via the stimulus unit 12.

Once the first control knob 44 has been selected, the handler 60 then sets the second control knob 46 to a desired position, via reference to the indicia 46A, for a desired tension threshold. As stated previously, the second control knob 46 enables the handler 60 to set a desired tension threshold at which at least one stimulus correction will be initiated by the microcontroller 38 and the at least one stimulus correction will be generated by one or both of the stimulus unit 12 or the audible indicator 52. Generally, the handler 60 may input the desired tension threshold into the microcontroller 38 via the second control knob 46 based on various reasons, including the size and strength of the animal 70, the distance at which the handler desires to maintain the animal 60 relative to the handler 70 (i.e. a desired heel distance), and other suitable reasons of the like for inputting and/or setting the desired tension threshold into the microcontroller 38 via the second control knob 46.

Once the second control knob 44 has been selected, the handler 60 may then set the third control knob 48 to a desired position, via reference to the indicia 48A, for a desired shock correction. As stated previously, the third control knob 48 enables the handler 60 to set a desired shock correction at which at least one shock stimulus correction will be initiated by the microcontroller 38 and the at least one stimulus correction will be generated by the stimulus unit 12. Generally, the handler 60 may input the desired shock correction into the microcontroller 38 via the third control knob 48 based on various reasons, including the size and strength of the animal 70 and other suitable reasons of the like for inputting and/or setting the desired shock correction into the microcontroller 38 via the third control knob 48. During these training sessions, acts of setting the third control knob 48 to a desired position may be omitted if the handler 60 sets the first control knob 46 in the first position (i.e., only audible stimulus correction).

In one instance, the handler 60 may set each of the first control knob 44, the second control knob 46, and the third control knob 48 when the animal training apparatus 1 is fitted to the animal 70. In another instance, the handler 60 may set each of the first control knob 44, the second control knob 46, and the third control knob 48 prior to fitting the animal training apparatus 1 to the animal 70. Once the first control knob 44, the second control knob 46, and the third control knob 48 are set, the handler 60 may begin heel training sessions with the animal 70.

As the handler 60 walks the animal 70 with the animal training apparatus 1, any strain and/or tension is continuously measured by the strain gauge 34 when the animal 70 pulls and/or tugs on a leash 80 operably engaged with the animal training apparatus 1 and the handler 70. Generally, the strain is the deformation or displacement of material that results from an applied stress in the strain gauge 34. As such, the stress in this instance is the force applied to a material divided by the material's cross-sectional area. With this information, the strain gauge 34 converts the applied force caused by the animal 70 into an electrical signal that can be measured by the control unit 30, specifically the microcontroller 38. The strain gauge 34 sends this electrical signal to the strain gauge amplifier 36 via the first electrical connection “EC1” illustrated in FIG. 2A. As discussed previously, the strain gauge amplifier 36 converts the analog strain measurement to a digital value in order for the microcontroller 38 to utilize this measurement.

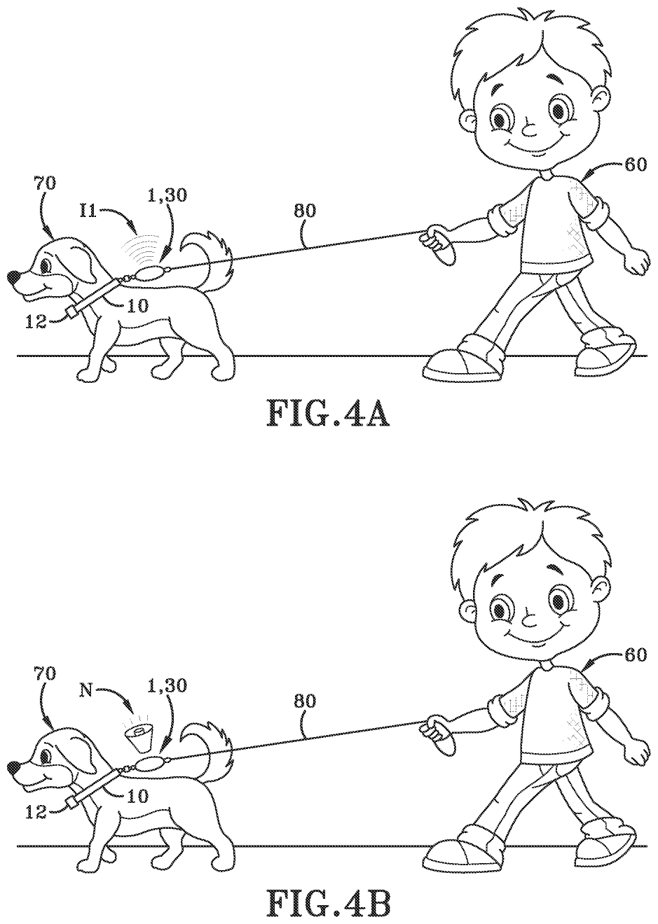

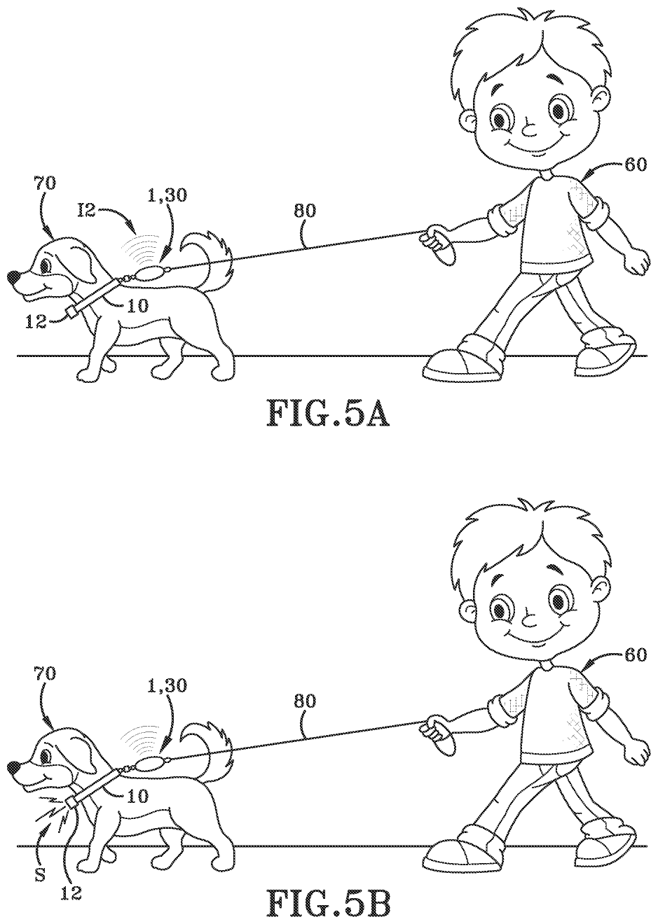

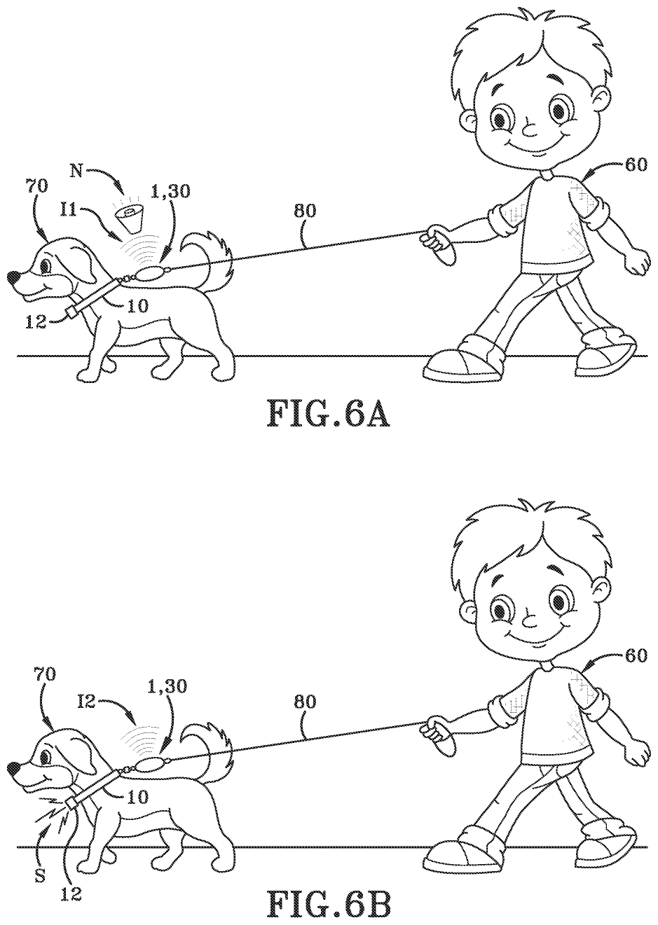

During the training session, the control unit 30 continuously monitor and measure the pulling force asserted on the strain gauge 34 between the animal 60 and the leash 80 held by the handler 70. If this digital tension value measured by the control unit 30 is less than the leash pull threshold set by the second control knob 46, the microcontroller 38 will be free from initiating any stimulus corrections to the animal 70. However, if this digital tension value is greater than the leash pull threshold set by the second knob 46, the microcontroller 38 will then initiate at least one stimulus correction to the animal 70 until the digital tension value is less than the leash pull threshold set by the second control knob 46. Such initiation by the microprocessor in is denoted by a symbol labeled “I1” for audible stimulus corrections as shown in FIGS. 4A-4B and 6A and “I2” for shock stimulus corrections as shown in FIGS. 5A-5B and 6B.

Referring to FIGS. 4A and 4B, the handler 60 provides the first control knob 44 in the first position. As stated above, the microcontroller 38 will send a signal to the audible indicator 52 to initiate at least one audible stimulus correction when the digital tension value is greater than the leash pull threshold set by the second knob 46 (see FIG. 4A). Upon initiation, the audible indicator 52 will emit a continuous audible stimulus correction (i.e., a noise and/or sound) to the animal 70 until the digital tension value is less than the leash pull threshold set by the second control knob 46. Such emitting of the audible stimulus correction is denoted by a horn symbol labeled “N” in FIG. 4B. The at least one audible stimulus correction emitted by the audible indicator 52 may be continuously repeated during the training session when the animal 70 pulls and/or tugs on the leash 80 causing the handler 60 to be pulled by the animal 70 (i.e., when the digital tension value is greater than the leash pull threshold set by the second knob 46).

Referring to FIGS. 5A and 5B, the handler 60 provides the first control knob 44 in the second position. As stated above, the microcontroller 38 will send a signal to the stimulus unit 12 to initiate at least one shock stimulus correction when the digital tension value is greater than the leash pull threshold set by the second knob 46 (see FIG. 5A). Upon initiation, the pulse generator 18 generates a continuous shock stimulus correction (i.e., an electrical shock) to the animal 70, via the at least one probe 16, until the digital tension value is less than the leash pull threshold set by the second control knob 46. Such generation of the shock stimulus correction is denoted by shock symbols labeled “S” in FIG. 5B. The at least one shock stimulus correction generated by the stimulus unit 12 may be continuously repeated during the training session when the animal 70 pulls and/or tugs on the leash 80 causing the handler 60 to be pulled by the animal 70 (i.e., when the digital tension value is greater than the leash pull threshold set by the second knob 46).

If the animal 60 is not responding to the intensity of the shock, the third control knob 48 may be rotated in a first direction to set to a more intense setting to deliver a more powerful shock. Alternatively, if the animal 60 is becoming skittish, fearful, or otherwise withdrawn, the third control knob 48 may be rotated in a second direction to set a less powerful or weaker shock.

Referring to FIGS. 6A and 6B, the handler 60 provides the first control knob 44 in the third position. As stated above, the microcontroller 38 will send a signal to the audible indicator 52 to initiate at least one audible stimulus correction when the digital tension value is greater than the leash pull threshold set by the second knob 46 (see FIG. 6A). Upon initiation, the audible indicator 52 will emit a continuous audible stimulus correction (i.e., a noise and/or sound) to the animal 70 until the digital tension value is less than the leash pull threshold set by the second control knob 46. Such emitting of the audible stimulus correction is denoted by a horn symbol labeled “N” in FIG. 6A. The at least one audible stimulus correction emitted by the audible indicator 52 may be continuously repeated during the training session when the animal 70 pulls and/or tugs on the leash 80 causing the handler 60 to be pulled by the animal 70 (i.e., when the digital tension value is greater than the leash pull threshold set by the second knob 46). After a delayed period, the microcontroller 38 will send a signal to the stimulus unit 12 to initiate at least one shock stimulus correction when the digital tension value is greater than the leash pull threshold set by the second knob 46 (see FIG. 6B). Upon initiation, the pulse generator 18 generates a continuous shock stimulus correction (i.e., an electrical shock) to the animal 70, via the at least one probe 16, until the digital tension value is less than the leash pull threshold set by the second control knob 46. Such generation of the shock stimulus correction is denoted by shock symbols labeled “S” in FIG. 6B. The at least one shock stimulus correction generated by the stimulus unit 12 may be continuously repeated during the training session when the animal 70 pulls and/or tugs on the leash 80 causing the handler 60 to be pulled by the animal 70 (i.e., when the digital tension value is greater than the leash pull threshold set by the second knob 46).

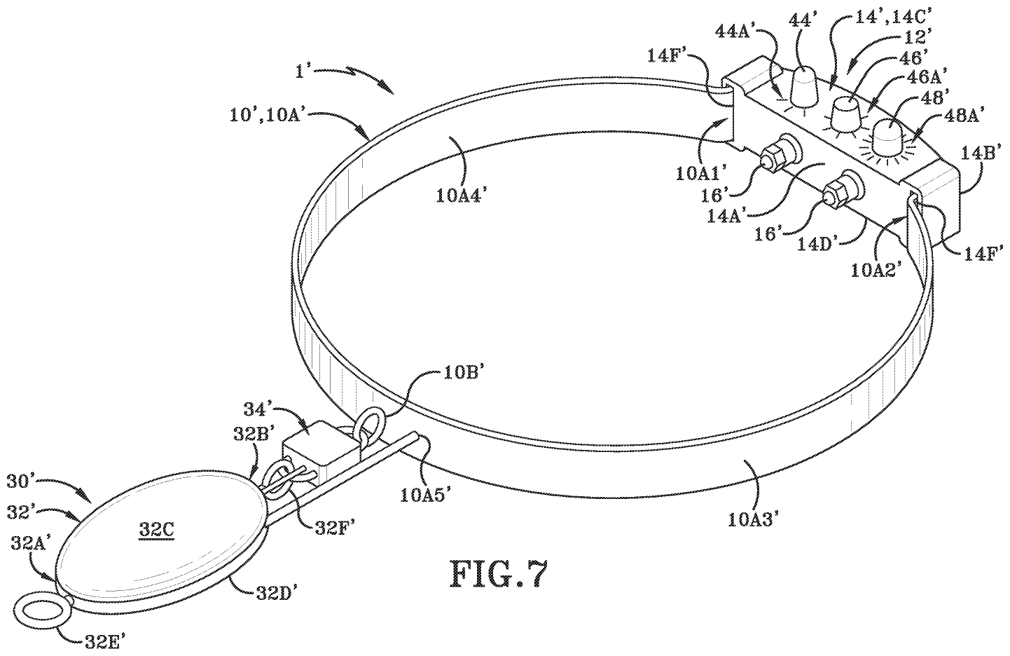

FIG. 7 is an alternative animal training apparatus 1′. The animal training apparatus 1′ is substantially similar to the animal training apparatus 1 described above and illustrated in FIGS. 1-6B, except as detailed below.

In the illustrated animal training apparatus 1′, the animal training apparatus 1′ includes a collar 10′ that is substantially similar to the collar 10 of the animal training apparatus 1 described above. More particularly, the animal training apparatus 1′ includes a strap potion 10A′ and an attachment member 10B′ of the collar 10′ that are substantially similar to the strap portion 10A and the attachment member 10B of the collar 10 of the animal training apparatus 1 described and illustrated above. Specifically, as to the strap portion 10A′, a first end 10A1′, a second end 10A2′, an outer surface 10A3′, an inner surface 10A4′, and a passageway 10A5′ of the strap portion 10A′ are substantially similar to the first end 10A1, the second end 10A2, the outer surface 10A3, the inner surface 10A4, and the passageway 10A5 of the strap portion 10A.

In the illustrated animal training apparatus 1′, the animal training apparatus 1′ also includes a stimulus unit 12′ that is substantially similar to the stimulus unit 12 of the animal training apparatus 1 described above. More particularly, the stimulus unit 12′ of the animal training apparatus 1′ includes a housing 14′, at least one probe 16′, a pulse generator (not illustrated), and a power supply (not illustrated) are substantially similar to the housing 14, the at least one probe 16, the pulse generator 18, and the power supply 20 of the stimulus unit 12 of the animal training apparatus 1 described and illustrated above. Specifically, as to the housing 14′, an inward facing side 14A′, an outward facing side 14B′, a top side 14C′, a bottom side 14D′, a chamber (not illustrated), and apertures 14F′ are substantially similar to the inward facing side 14A, the outward facing side 14B, the top side 14C, the bottom side 14D, the chamber (not illustrated), and the apertures 14F of the housing 14.

In the illustrated animal training apparatus 1′, the animal training apparatus 1′ also includes a control unit 30′ that is substantially similar to the control unit 30 of the animal training apparatus 1 described above. More particularly, the control unit 30′ of the animal training apparatus 1′ includes a housing 32′, a strain gauge (not illustrated), a stain gauge amplifier (not illustrated), a microcontroller (not illustrated), a battery (not illustrated), and a battery charging port (not illustrated) that is substantially similar to the housing 32, strain gauge 34, stain gauge amplifier 36, microcontroller 38, battery 40, and the battery charging port 42 of the control unit 30.

In this illustrated animal training apparatus 1′, however, a first control knob 44′ with indicia 44A′, a second control knob 46′ with indicia 46A′, and a third control knob 48′ with indicia 48A′ are operably engaged with the housing 14′ of the stimulus unit 12′. In this illustrated animal training apparatus 1′, the first control knob 44′, the second control knob 46′, and the third control knob 48′ operate and operatively communicate with the microcontroller of the control unit 30′ substantially similar to how the first control knob 44, the second control knob 46, and the third control knob 48 operate and operatively communicate with the microcontroller 38 of the control unit 30. Additionally, indicia 44A′, indicia 46A′, indicia 48A′ are provide on the top side 14C′ of the housing 14′ in comparison to the indicia 44A, indicia 46A, indicia 48A being provided on the top wall 32C of the housing 32 in the animal training apparatus 1 described above.

In the illustrated animal training apparatus 1′, the first control knob 44′, the second control knob 46′, and the third control knob 48′ are operatively connected with the microcontroller of the control unit 30′ via at least one electrical connection to provide communication between the microcontroller and each of the first control knob 44′, the second control knob 46′, and the third control knob 48′. In the illustrated embodiment, each of the first control knob 44′, the second control knob 46′, and the third control knob 48′ is operatively connected with the microcontroller of the control unit 30′ via a wired connection. In one exemplary embodiment, each of the first control knob 44′, the second control knob 46′, and the third control knob 48′ is operatively connected with the microcontroller of the control unit 30′ via a wireless or peer-to-peer connection. Examples of suitable wireless connection include, but are not limited to, Bluetooth technology, infrared technology, WiFi Direct technology, near field communication (NFC), cellular technologies, and other suitable technologies of the like to operatively connect each of the first control knob 44′, the second control knob 46′, and the third control knob 48′ with the microcontroller of the control unit 30′ via wireless connections.

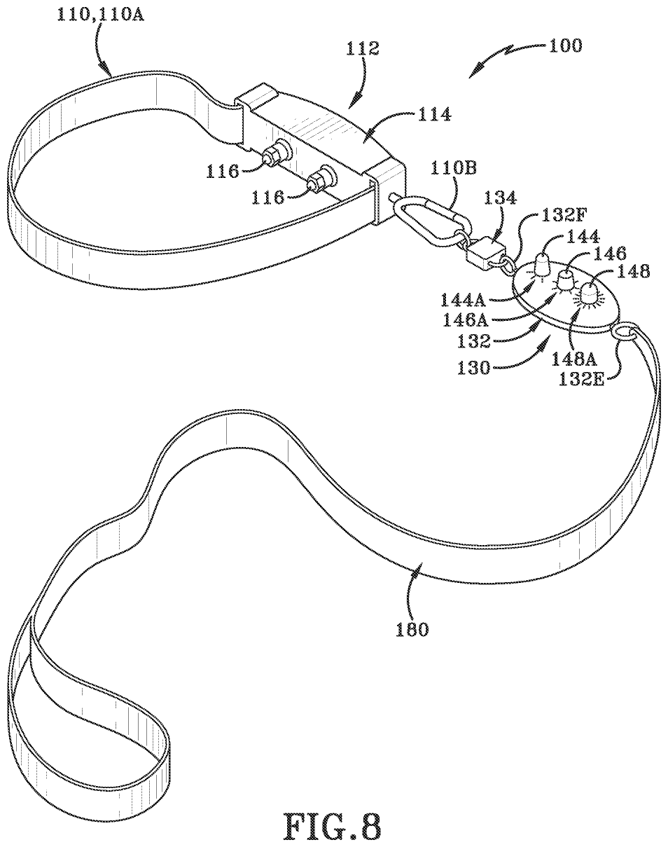

FIG. 8 illustrates another animal training apparatus 100. The animal training apparatus 100 is similar to the animal training apparatus 1 described above and illustrated in FIGS. 1-6B, except as detailed below.

In the illustrated embodiment, a preexisting collar 110 with a preexisting stimulus unit 112 are operably engaged with and/or operatively connected with a control unit 130 of the animal training apparatus 100. As illustrated in FIG. 8, the preexisting collar 110 generally includes a strap portion 110A that fits to a neck or head region of an animal and an attachment member 110B that operably engages with a housing 114 of the preexisting stimulus unit 114 for enabling a handler to operably engage the control unit 130 with the preexisting collar 110, which is described in more detail below. As such, the preexisting stimulus unit 112 also includes at least one probe 116 that operably engages with the housing 114. The at least one probe 116 operably engages with a neck or head region of an animal to provide shock stimulus correction for preexisting training purposes. As such, the collar 110 and stimulus unit 112 may be any available and/or existing animal shock collar.

In the illustrated embodiment, the control unit 130 is substantially similar to the control unit 30 of the animal training apparatus 1 described above. More particularly, the control unit 130 of the animal training apparatus 1 includes a housing 132 with a leash attachment member 132E and a collar attachment member 132F, a strain gauge 134, a stain gauge amplifier (not illustrated), a microcontroller (not illustrated), a battery (not illustrated), and a battery charging port (not illustrated) that is substantially similar to the housing 32 with the leash attachment member 32E and the collar attachment member 32F, strain gauge 34, stain gauge amplifier 36, microcontroller 38, battery 40, and the battery charging port 42 of the control unit 30. As illustrated in FIG. 8, the control unit 130 operably engages with the preexisting collar 110 and the stimulus unit 112 via the attachment member 110B and the collar attachment member 132F. In the illustrated embodiment, the control unit 130 also operatively connects with the stimulus unit 112 via wireless connections. In other words, the stimulus unit 112 and the control unit 130 are wirelessly paired with one another. Examples of suitable wireless connection include, but are not limited to, Bluetooth technology, infrared technology, WiFi Direct technology, near field communication (NFC), cellular technologies, and other suitable technologies of the like to operatively connect the stimulus unit 112 with the control unit 130 via wireless connections.

The control unit 130 also includes at least one control knob that operatively connects with the microcontroller of the control unit 130. In the illustrated embodiment, the control unit 130 also includes a first control knob 144 with an indicia 144A, a second control knob 146 with an indicia 146A, and a third control knob 148 with an indicia 148A. The first control knob 144, the second control knob 146, and the third control knob 148 of the control unit 130 operate and perform substantially similar to the first control knob 44, the second control knob 46, and the third control knob 48 of the control unit 30. In this illustrated embodiment, however, the control unit 130 is wirelessly interfaced and wirelessly connected with the existing stimulus unit 112. As such, the first control knob 144, the second control knob 146, and the third control knob 148 all control the same modes as in the first embodiment 10. Not all of the control knobs 144, 146, 148 may be needed depending on the functionality of the existing shock collar. The control unit 130 has the same internal parts with an added transmitter (not shown) and less any wire to physically connect the control unit 130 with the existing shock collar in order to facilitate a wireless interface with the existing shock collar.

The control unit 130 is also configured to be operably engaged with an existing leash 180 via the leash attachment member 132E. Any suitable engagement mechanism may be used to operably engage the leash 180 with the leash attachment member 132 of the control unit.

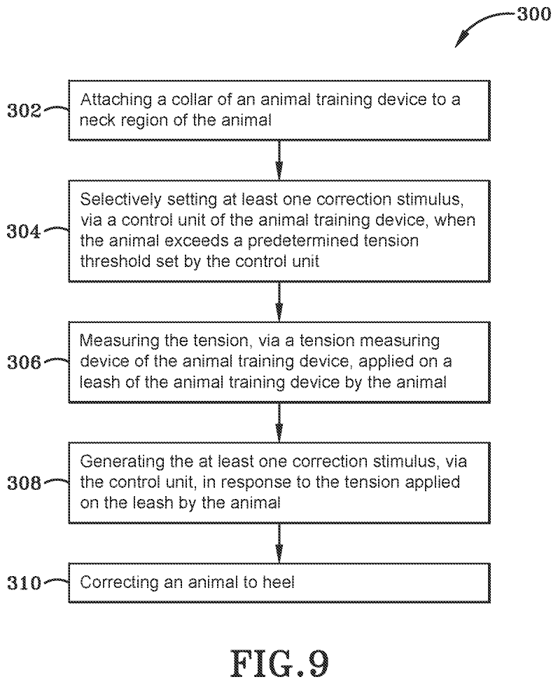

FIG. 9 is a method 200 of correcting an animal to heel. An initial step 202 of the method 200 comprises attaching a collar of an animal training device to a neck region of the animal. Another step 204 of the method 200 comprises selectively setting at least one correction stimulus, via a control unit of the animal training device, when the animal exceeds a predetermined tension threshold set by the control unit. Another step 206 of the method 200 comprises measuring the tension, via a tension measuring device of the animal training device, applied on a leash of the animal training device by the animal. Another step 208 of the method 200 comprises generating the at least one correction stimulus, via the control unit, in response to the tension applied on the leash by the animal. Another step 210 of the method 200 comprises correcting an animal to heel.

In other exemplary embodiments, the method 200 may include optional steps of correcting an animal to heel. Optional steps may include selectively setting a microprocessor of the control unit, via a first control knob of the control unit, to a first correction stimulus; and activating an audible device of the control unit to generate an audible correction when the animal exceeds the predetermined tension threshold set by the control unit. Optional steps may include selectively setting the microprocessor of the control unit, via the first control knob of the control unit, to a second correction stimulus; and activating a pulse generator of a stimulus unit of the animal training device to generate a shock correction when the animal exceeds the predetermined tension threshold set by the control unit. Optional steps may include selectively setting the microprocessor of the control unit, via the first control knob of the control unit, to a third correction stimulus; activating the audible device of the control unit to generate the audible correction when the animal exceeds the predetermined tension threshold set by the control unit; and activating the pulse generator of the stimulus unit to generate the shock correction when the animal exceeds the predetermined tension threshold set by the control unit. An optional step may include selectively setting the microprocessor of the control unit, via a second control knob of the control unit, to the predetermined tension threshold from a range of tension thresholds. An optional step may include selectively setting a stimulus unit of the animal training device, via a third control knob of the control unit, to a predetermined shock correction from a range of shock corrections. An optional step may include emitting light, via a visual indicator of the control unit, when the tension exceeds the predetermined tension threshold applied on the leash by the animal. An optional step may include connecting the control unit with the stimulus unit, via an electrical connection, to enable a stimulus unit to generate at least one correction stimulus to the animal, wherein the electrical connection is a wired electrical connection between the stimulus unit and the control unit. An optional step may include connecting the control unit with the stimulus unit, via an electrical connection, to enable a stimulus unit to generate at least one correction stimulus to the animal, wherein the electrical connection is a wireless electrical connection between the stimulus unit and the control unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium, or multiple computer readable storage media, (e.i., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey a relationship between the fields. However, any suitable mechanism may be used to establish a relationship between information in fields of a data structure, including through the use of pointers, tags, or other mechanisms that establish a relationship between data elements.

All definitions, as defined and used herein, should be understood to control over dictionary definitions, definitions in documents incorporated by reference, and/or ordinary meanings of the defined terms.

“ Logic,” as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microcontroller, discrete logic like a processor (e.g., microcontroller), an application specific integrated circuit (ASIC), a programmed logic device, a memory device containing instructions, an electric device having a memory device, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “element A and/or element B,” when used in conjunction with open-ended language such as “comprising” can refer, in one embodiment, to element A only (optionally including elements other than element B); in another embodiment, to element B only (optionally including elements other than element A); in yet another embodiment, to both element A and element B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected,” “attached” or “coupled” to another feature or element, it can be directly connected, attached or coupled to the other feature or element or intervening features or elements that may be present. In contrast, when a feature or element is referred to as being “directly connected,” “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper,” “above,” “behind,” “in front of,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly,” “downwardly,” “vertical,” “horizontal,” “lateral,” “transverse,” “longitudinal,” and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. An animal training apparatus, comprising:
a collar adapted to operably engaged with an animal;
a stimulus unit operably engaged with the collar;
a control unit operably engaged with the collar and operatively connected with the stimulus unit, wherein the control unit is adapted to operably engage with a leash cord; and
a tension measuring device of the control unit operably engaged with the collar and adapted for measuring tension in the leash cord and producing an electrical signal when the tension exceeds a predetermined tension threshold;
wherein the control unit is selectively programmable to generate at least one correction stimulus to the animal when the animal exceeds the predetermined tension threshold set in the control unit.

2. The animal training device of claim 1, wherein the control unit comprises:
a microcontroller operatively connected with the stimulus unit; and
at least one control knob operatively connected with the microcontroller;
wherein the at least one control knob is adapted to selectively set the microcontroller to generate the at least one correction stimulus to the animal when the animal exceeds the predetermined tension threshold.

3. The animal training device of claim 2, wherein the control unit further comprises:
at least one audible device operatively connected with the microprocessor for generating audible sound when the tension exceeds the predetermined tension threshold;
wherein the stimulus unit comprises:
a pulse generator operatively connected with the microprocessor and having at least one probe for generating a desired shock power to the at least one probe; and
wherein the at least one control knob comprises:
a first control knob operatively connected with the microcontroller for controlling the at least one correction stimulus generated by one or both of the stimulus unit and the at least one audible device.

4. The animal training device of claim 3, wherein the control unit further comprises:
a first mode provided by the first control knob for generating a first correction stimulus by the at least one audible device.

5. The animal training device of claim 4, wherein the control unit further comprises:
a second mode provided by the first control knob for generating a second correction stimulus by the stimulus unit.

6. The animal training device of claim 5, wherein the control unit further comprises:
a third mode provided by the first control knob for generating a third correction stimulus by the at least one audible device and the stimulus unit.

7. The animal training device of claim 3, wherein the at least one control knob further comprises:
a second control knob operatively connected with the microcontroller;
wherein the second control knob is adapted for setting the predetermined tension threshold.

8. The animal training device of claim 7, wherein the at least one control knob further comprises:
a third control knob operatively connected with the microcontroller;
wherein the third control knob is adapted for setting a predetermined shock power for the pulse generator of the stimulus unit.

9. The animal training device of claim 2, wherein the control unit further comprises:
an amplifier operatively engaged with the tension measuring device and the microprocessor;
wherein the amplifier is configured to convert the electrical signal from an analog value to a digital value.

10. The animal training device of claim 2, wherein the control unit further comprises:
a visual indicator operatively engaged with the microprocessor;
wherein the visual indicator is adapted to emit light when the tension exceeds a predetermined tension threshold.

11. The animal training device of claim 1, further comprising:
an electrical connection operatively connecting the control unit with the stimulus unit for to enable the stimulus unit to generate at least one correction stimulus to the animal.

12. The animal training device of claim 11, wherein the electrical connection is a wired electrical connection between the stimulus unit and the control unit.

13. The animal training device of claim 11, wherein the electrical connection is a wireless electrical connection between the stimulus unit and the control unit.

14. A method of correcting an animal to heel, comprising steps of:
attaching a collar of an animal training device to a neck region of the animal;
selectively setting at least one correction stimulus, via a control unit of the animal training device, when the animal exceeds a predetermined tension threshold set in the control unit;
measuring a tension force, via a tension measuring device of the animal training device, applied on a leash of the animal training device by the animal;
generating the at least one correction stimulus, via the control unit, in response to the tension applied on the leash by the animal; and
correcting an animal to heel.

15. The method of claim 14, further comprising:
selectively setting a microprocessor of the control unit, via a first control knob of the control unit, to a first correction stimulus; and
activating an audible device of the control unit to generate an audible correction when the animal exceeds the predetermined tension threshold set by the control unit.

16. The method of claim 15, further comprising:
selectively setting the microprocessor of the control unit, via the first control knob of the control unit, to a second correction stimulus; and
activating a pulse generator of a stimulus unit of the animal training device to generate a shock correction when the animal exceeds the predetermined tension threshold set by the control unit.

17. The method of claim 16, further comprising:
selectively setting the microprocessor of the control unit, via the first control knob of the control unit, to a third correction stimulus;
activating the audible device of the control unit to generate the audible correction when the animal exceeds the predetermined tension threshold set by the control unit; and
activating the pulse generator of the stimulus unit to generate the shock correction when the animal exceeds the predetermined tension threshold set by the control unit.

18. The method of claim 17, further comprising:
selectively setting the microprocessor of the control unit, via a second control knob of the control unit, to the predetermined tension threshold from a range of tension thresholds.

19. The method of claim 18, further comprising:
selectively setting a stimulus unit of the animal training device, via a third control knob of the control unit, to a predetermined shock correction from a range of shock corrections.

20. The method of claim 14, further comprising:
emitting light, via a visual indicator of the control unit, when the tension exceeds the predetermined tension threshold applied on the leash by the animal.

21. The method of claim 14, further comprising:
connecting the control unit with the stimulus unit, via an electrical connection, to enable a stimulus unit to generate at least one correction stimulus to the animal, wherein the electrical connection is a wired electrical connection between the stimulus unit and the control unit.

22. The method of claim 14, further comprising:
connecting the control unit with the stimulus unit, via an electrical connection, to enable a stimulus unit to generate at least one correction stimulus to the animal, wherein the electrical connection is a wireless electrical connection between the stimulus unit and the control unit.
